(19) United States
(12) Patent Application Publication
(10) Pub. No.: US 2012/0074141 A1
(43) Pub. Date: Mar. 29, 2012

(54) BI-FUNCTIONAL COOKWARE LID

(76) Inventor: Currimjee Abbas, Grand Bay (MU)

(21) Appl. No.: 13/072,255

(22) Filed: Mar. 25, 2011

(30) Foreign Application Priority Data
Sep. 27, 2010 (IN) 2677/MUM/2010

(51) Int. Cl. A47J 36/06; A47G 19/02

(52) U.S. Cl. 220/212.5; 220/573.1

(57) ABSTRACT

A bi-functional lid comprises a food covering section having a concave top wall and a peripheral wall, a knob on the outer surface of the concave top wall and laterally extending handles originating from the outer surface of the peripheral wall. The food covering section of a bi-functional lid is made up of multilayer sheets.

### CROSS-REFERENCE TO RELATED APPLICATIONS

This application claims the benefit from Indian Patent Application No. 2677/MUM/2010 filed on Sep. 27, 2010, the contents of which are incorporated herein by reference.

### FIELD OF THE INVENTION

The present invention relates to a bi-functional cookware lid which can be used as a lid during the cooking process and as a serving dish for serving food.

### BACKGROUND AND PRIOR ART

In the conventional practice of preparing food, cooking is carried out in cookware. Once the food is cooked it is then served on a serving dish. This process requires separate vessels for cooking and serving the food. Thus, it increases both cleaning load and the time required for overall process. In today's age there is a great need for having cookware which is energy efficient, economical to store and which reduces cooking time.

U.S. Pat. No. 4,483,317 discloses food serving and warming apparatus in which the serving dishes are substituted for cooking pan lids and preheated using the live, free steam from the cooking process. These serving dishes are made up of ceramic and other heat retaining material.

U.S. Pat. No. 4,880,951 provides a multi-component kit for cooking food in a microwave oven or in a thermal oven. The cover member of the system if inverted, functions as a serving dish for cooked foods after the completion of cooking process. For this purpose, appropriate peripheral pedestals, in the form of glass, plastic or ceramic buttons, are provided in the convex outer surface of the cover member. The cover member is fabricated from microwave-transmissive glass or ceramic material.

The use of bi-functional lids will be convenient to reduce the load of the overall cooking process. The prior art illustrates bi-functional lids which are fabricated from a single layer of material sheet wherein these lids are less curved. When the food is served on such bi-functional lids it gets rapidly cooled down. The lukewarm food becomes less appealing as compared to hot food. This then requires reheating of the food and increase the overall cooking time. Besides, reheating of the food material will cause the overcooking of food and loss of vital minerals and vitamins from the food. Furthermore, in a cookware having a conventional flat lid, proper circulation of steam is not possible leading to uneven cooking of food material and loss of its nutritional value. Also, this will require additional time for the cooking process.

Hence, there is a need to fabricate a bi-functional lid which overcomes the problems presented by the prior art.

### SUMMARY OF THE INVENTION

The invention relates to a bi-functional lid for a cookware comprising:
(a) a food covering section having a concave top wall and a peripheral wall wherein the food covering section comprises a multilayered sheet;
(b) a knob on an outer surface of the concave top wall; and
(c) at least one laterally extending handle originating from an outer surface of the peripheral wall;
   wherein the bi-functional lid when inverted functions as a serving dish, to receive a food material and the knob is enabled to provide stability to the bi-functional lid.

### BRIEF DESCRIPTION OF THE DRAWINGS

For a more complete understanding of the invention, reference should now be made to the embodiment illustrated in greater detail in the accompanying drawing and described below by way of examples of the invention.

FIG. 1 is an isometric side view of the bi-functional cookware lid in accordance with an embodiment of the invention.

FIG. 2 is a sectional side view of the bi-functional cookware lid in accordance with an embodiment of the invention.

FIG. 3 is a partial sectional side view of the bi-functional cookware lid showing its multilayered sheets in accordance with an embodiment of the invention.

FIG. 4 is a top view of the bi-functional cookware lid in accordance with an embodiment of the invention.

FIG. 5 is an isometric view of the bi-functional cookware lid positioned on a saucepan in accordance with an embodiment of the invention.

It is to be understood that the drawings are not to scale and are schematic in nature. In certain instances, details which are not necessary for an understanding of the present invention or which renders other details difficult to perceive, may be omitted. It should be understood, of course, that the invention is not necessarily limited to the particular embodiments illustrated herein.

### DETAILED DESCRIPTION

In describing the embodiments of the invention, specific terminology is used for the sake of clarity. However, it is not intended that the invention be limited to the specific terms so selected and it is to be understood that each specific term includes all technical equivalents that operate in a similar manner to accomplish a similar purpose.

While the present invention is susceptible of embodiments in various forms, there will hereinafter be described presently preferred embodiments with the understanding that the present disclosure is to be considered an exemplification of the invention and is not intended to limit the invention to the specific embodiments described.

The invention relates to a bi-functional lid for a cookware comprising:
(a) a food covering section having a concave top wall and a peripheral wall wherein the food covering section comprises a multilayered sheet;
(b) a knob on an outer surface of the concave top wall; and
(c) at least one laterally extending handle originating from an outer surface of the peripheral wall;
   wherein the bi-functional lid when inverted functions as a serving dish, to receive a food material and the knob is enabled to provide stability to the bi-functional lid.

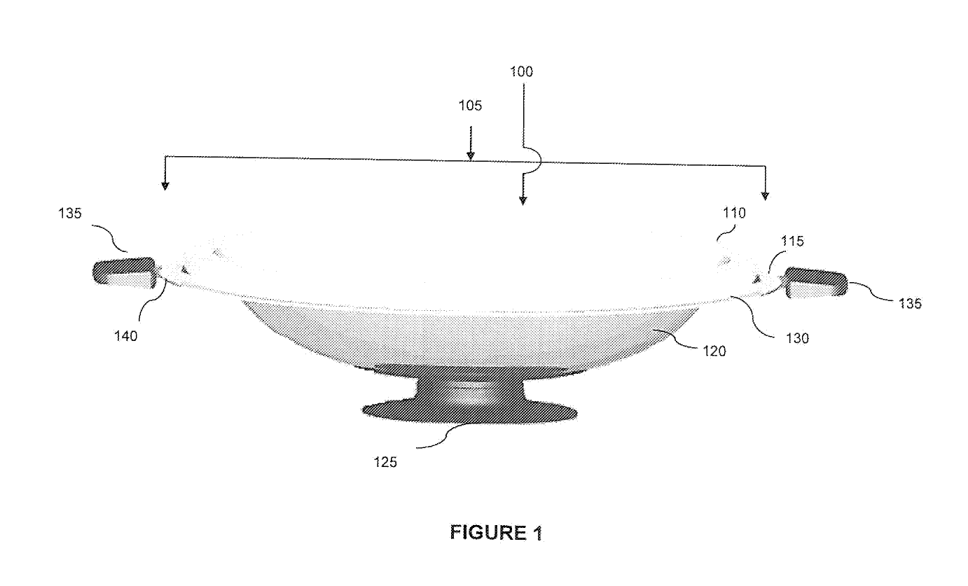

As disclosed in FIG. 1, the major components of a bi-functional lid (100) comprises a food covering section (105), a knob (125) and a laterally extending handle (135).

According to an embodiment, the food covering section (105) comprises a concave top wall (120) and a peripheral wall (130). The peripheral wall (130) comprises an inner peripheral wall (110) and an outer peripheral wall (115).

According to an embodiment, the concave top wall (120) of the food covering section (105) is sufficiently curved so that its volumetric content is substantially increased. The concave top wall of the bi-functional lid favours more efficient healthy cooking since the condensation occurring on the inner surface of a food covering section (105) of the bi-functional lid (100) drips on to the contents of the cookware. As this phenomenon is constantly repeated, it results in a regular circulation of hot, moist vapour that cooks the ingredients with retention of their inherent food value.

According to a further embodiment, the knob (125) is positioned on the outer surface of the concave top wall (120). The knob (125) has a flat and circular base with a small thick solid rod. However, one skilled in the art will appreciate that the knobs can be oval, spherical, square, rectangular or any other suitable geometrical forms in shape. During cooking process, the knob (125) assists the user to remove the bi-functional lid (100) kept on the cookware and monitor the progress of cooking process. The knob (125) permits the bi-functional lid (100) to be employed as a serving dish by inverting the lid (100) and allowing it to rest on the knob (125). The knob (125) can be made from various materials such as cast iron, stainless steel, brass, cast aluminium, copper, bakelite or other plastic, and combinations thereof.

According to an embodiment, the knob (125) is can also be provided with an additional support system (not shown). The support system can be in the form of a receiver, a pedestal or a holder to receive and stabilize the knob.

According to an embodiment, the laterally extending handle (135) is attached to the outer peripheral wall (115) through a bracket (140). When food is served on the bi-functional lid (100), the laterally extending handles (135) enable the user to hold and carry the lid cum serving dish (100) to the required place. The laterally extending handle (135) can be made from cast iron, stainless steel, brass, cast aluminium, copper, bakelite or other plastic and combinations thereof. The bracket (140) can be used made of materials such as cast iron, stainless steel, brass, cast aluminium, copper, bakelite or other plastic and combinations thereof.

According to an embodiment, the laterally extending handles (135) can also be attached directly to the outer peripheral wall (115).

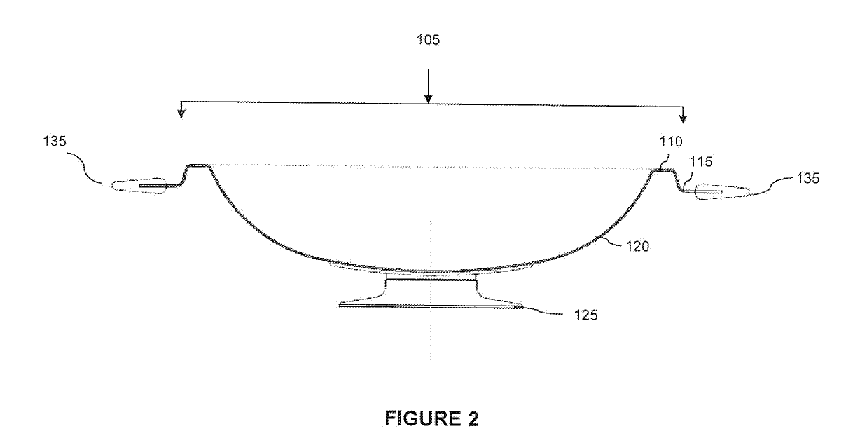

According to an embodiment, FIG. 2 illustrates a sectional side view of the bi-functional cookware lid in accordance with an embodiment of the invention.

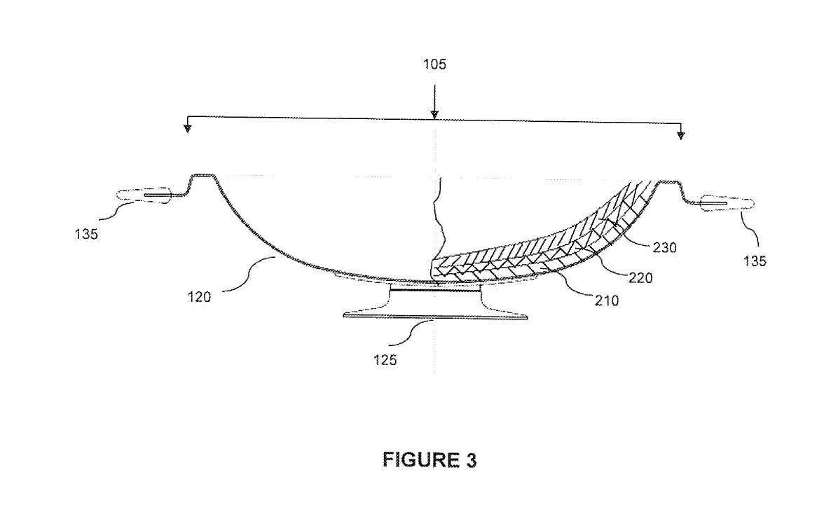

According to an embodiment as shown in FIG. 3, the food covering section (105) of the bi-functional lid (100) is made up of multilayer sheets (210, 220 and 230).

According to a further embodiment, the multilayered sheet of the food covering section (105) comprises at least two sheets coupled together. The components such as metal, metal alloy, metal composite, heat resistant plastics, glass ceramic, microwave-transmissive materials or a combination thereof can be used for fabricating the multilayered sheet of the food covering section (105). The metals such as aluminum, carbon, nickel, chromium, iron, copper, magnesium, silicon, manganese, zinc, titanium or a combination thereof can be used for fabricating the multilayered sheet of the food covering section (105). The metal alloys such as duralumin, stainless steel, wootz steel, carbon steel, brass, bronze, manganin, german silver, HSLA steel, maraging steel, high speed steel, or a combination thereof can be used for fabricating the material of the multilayered sheet of the food covering section (105). The metal composites such as aluminum, carbon, nickel, chromium, iron, copper, magnesium, silicon, manganese, zinc, titanium, cast iron, stainless steel, brass, bronze, cast aluminium, copper or a combination thereof can be used for fabricating the multilayered sheet of the food covering section (105).

According to an embodiment the food covering section (105) is fabricated of (a) an outer layer made of stainless steel alloy; (210), (b) a middle layer made of at least one of aluminium and aluminum alloy; (220) and, (c) an inner layer made of polished stainless steel (230).

According to an embodiment, the inner layer of polished stainless steel (230) enables heat retention of the food material when food is served on the bi-functional lid. Thus, food remains hot for a long period of time and time involved in reheating the food material is also saved. The multilayer sheets (210, 220, 230) of the food covering section (105) facilitate the reduction of the cooking time. They also retain the nutritional value and heat of the food material during cooking and serving process.

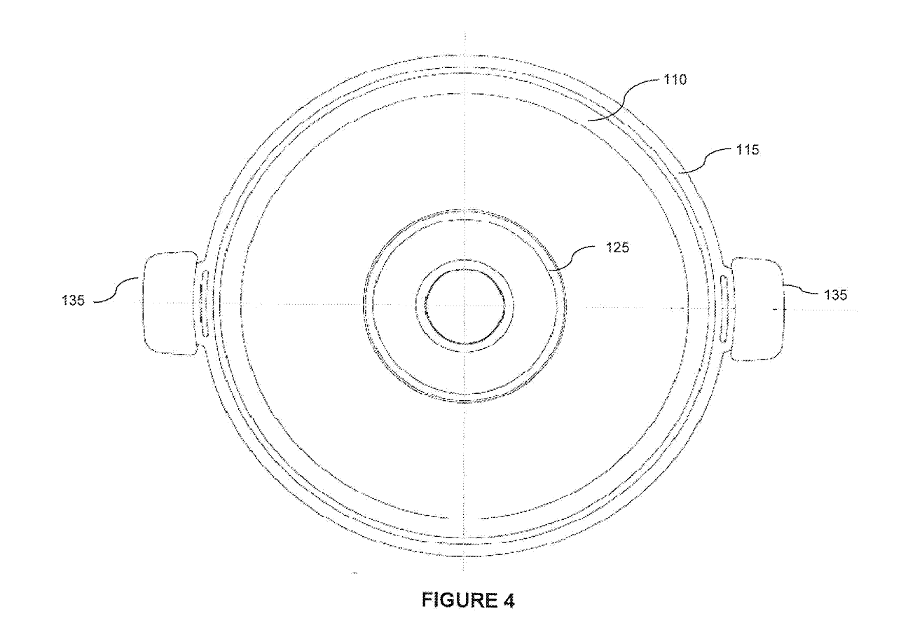

According to an embodiment, FIG. 4 illustrates a top view of the bi-functional lid with the knob. While the generally circular shape of the lid has been illustrated as an embodiment, it should be understood that the shape also can be oval, square, rectangular or other suitable geometrical forms.

According to an embodiment, the bi-functional lid can be used for various cookwares such as fry pan, saucepan, saucier, saute pan, stock pot, stir fry pan, omelet pan, casserole, sauce pot and skillet.

According to an embodiment, plurality of the similarly configured bi-functional lids are provided and designed to fit over and engage standard size cookware.

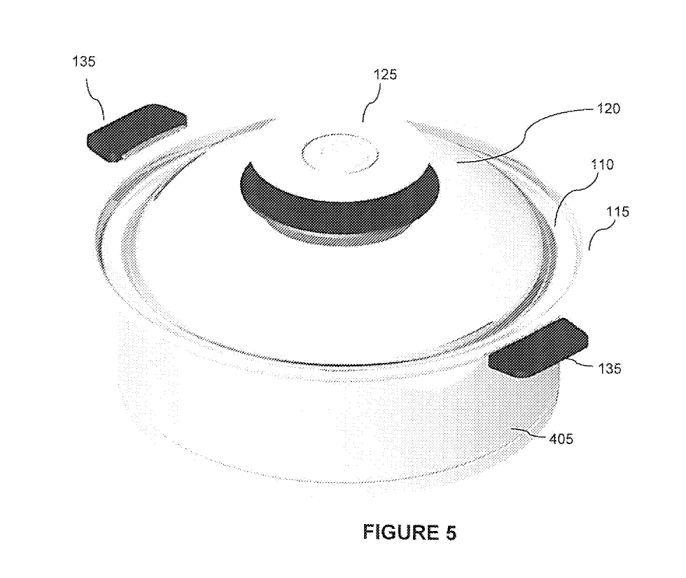

According to an embodiment as shown in FIG. 5 the bi-functional lid (100) placed on the top of the saucepan (405) and the grooved inner peripheral wall (110) securely engages the top of the saucepan (405). The bi-functional cookware lid (100) can be used as a lid for the saucepan (405) as well as a serving dish.

In use and operation, the various sizes and embodiments of the invention function similarly. In respect of the features described above in relation to one or more embodiments, it should be understood that any two or more of the features may be combined in any appropriate combination.

What is claimed is:

1. A bi-functional lid for a cookware comprising:
(a) a food covering section having a concave top wall and a peripheral wall wherein the food covering section comprises a multilayered sheet;
(b) a knob on an outer surface of the concave top wall; and
(c) at least one laterally extending handle originating from an outer surface of the peripheral wall;
wherein the bi-functional cookware lid when inverted functions as a serving dish, to receive a food material and the knob is enabled to provide stability to the bi-functional lid.

2. The bi-functional lid of claim 1, wherein the multilayered sheet comprises at least two sheets coupled together.

3. The bi-functional cookware lid of claim 1, wherein the multilayered sheet is made of metal, metal alloy, metal composite, heat resistant plastic, glass ceramic, microwave-transmissive materials or a combination thereof.

4. The multi-layered sheet of claim 3, wherein the metal is selected from a group consisting aluminum, carbon, nickel, chromium, iron, copper, magnesium, silicon, manganese, zinc, titanium, or a combination thereof.

5. The multi-layered sheet of claim 3, wherein the metal alloy is selected from a group consisting duralumin, stainless steel, wootz steel, carbon steel, brass, bronze, manganin, german silver, HSLA steel, maraging steel, high speed steel, or a combination thereof.

6. The multi-layered sheet of claim 3, wherein the metal composite is selected from a group consisting aluminum, carbon, nickel, chromium, iron, copper, magnesium, silicon, manganese, zinc, titanium, cast iron, stainless steel, brass, bronze, cast aluminium, copper or a combination thereof.

7. The bi-functional cookware lid of claim 1, wherein the multi-layered sheet comprises:
(a) an outer layer made of stainless steel alloy;
(b) a middle layer made of at least one of aluminium and aluminum alloy; and
(c) an inner layer made of polished stainless steel.

8. The bi-functional lid of claim 1, wherein the cookware comprises a fry pan, saucepan, saucier, saute pan, stock pot, stir fry pan, omelet pan, casserole, sauce pot and skillet.

9. The bi-functional lid of claim 1, further comprising a support system to stabilize the knob.
